(19) United States
(12) Patent Application Publication
(10) Pub. No.: US 2024/0170794 A1
(43) Pub. Date: May 23, 2024

(54) Battery Module

(71) Applicant: Prime Planet Energy & Solutions, Inc., Tokyo (JP)

(72) Inventor: Tetsuji OMURA, Kobe-shi (JP)

(21) Appl. No.: 18/499,211

(22) Filed: Nov. 1, 2023

(30) Foreign Application Priority Data
Nov. 22, 2022 (JP) 2022-186364

(51) Int. Cl. H01M 50/291; H01M 50/209; H01M 50/293

(52) U.S. Cl. CPC H01M 50/291; H01M 50/209; H01M 50/293

(57) ABSTRACT

An insulating member includes: a base; and a plurality of protrusions each protruding from the base in a first direction, the plurality of protrusions being in abutment with at least one of a plurality of battery cells. The protrusions include a first protrusion, a second protrusion arranged beside the first protrusion along a second direction orthogonal to the first direction, and a third protrusion arranged beside the first protrusion along a third direction that is orthogonal to the first direction and that intersects the second direction. Ribs each protruding from the base in the first direction are provided between the first protrusion and the second protrusion and between the first protrusion and the third protrusion. In a state in which the insulating member is detached from the battery module, a width of each of the ribs is smaller than a width of each of the protrusions.

### CROSS REFERENCE TO RELATED APPLICATIONS

This nonprovisional application is based on Japanese Patent Application No. 2022-186364 filed on Nov. 22, 2022 with the Japan Patent Office, the entire contents of which are hereby incorporated by reference.

### BACKGROUND OF THE INVENTION

### Field of the Invention

The present technology relates to a battery module.

### Description of the Background Art

Japanese Patent Laying-Open No. 2020-004556 discloses a cushioning sheet for a battery module, the cushioning sheet being intended to elastically support a battery cell at the time of charging and securely provide a reaction force also at the time of discharging. The cushioning sheet includes a base portion and an elastic protrusion protruding from the base portion toward the battery cell.

Japanese National Patent Publication No. 2022-521195 discloses an insulating plate for a secondary battery, the insulating plate including: a body portion; and a protuberance adhered to an upper surface of the body portion and protruding upward.

In a field different from the field of batteries, for example, each of Japanese Patent Laying-Open No. 2013-215312 and Japanese Patent Laying-Open No. 2000-093487 employs a structure similar to the structure described above.

### SUMMARY OF THE INVENTION

From the viewpoint of reducing the size of the battery module, the thickness of the cushioning sheet is desirably thin. On the other hand, from the viewpoint of securely supporting the battery cell, the height of the elastic protrusion is desirably high. In order to satisfy both of these demands, the base portion is formed to be thin. However, if the base portion is too thin, handleability of the cushioning sheet may be deteriorated when assembling the cushioning sheet between a plurality of battery cells.

It is an object of the present technology to provide a battery module to attain high handleability of an insulating member assembled between a plurality of battery cells.

The present technology provides the following battery module.

[1] A battery module comprising: a plurality of battery cells arranged in a first direction; and an insulating member provided between the plurality of battery cells, wherein the insulating member includes a base and a plurality of protrusions each protruding from the base in the first direction, the plurality of protrusions being in abutment with at least one of the plurality of battery cells, the protrusions include a first protrusion, a second protrusion arranged beside the first protrusion along a second direction orthogonal to the first direction, and a third protrusion arranged beside the first protrusion along a third direction that is orthogonal to the first direction and that intersects the second direction, ribs each protruding from the base in the first direction are provided between the first protrusion and the second protrusion and between the first protrusion and the third protrusion, and in a state in which the insulating member is detached from the battery module, a width of each of the ribs is smaller than a width of each of the protrusions.

[2] The battery module according to [1], wherein the ribs are formed to connect the first protrusion and the second protrusion to each other and connect the first protrusion and the third protrusion to each other.

[3] The battery module according to [1] or [2], wherein in the state in which the insulating member is detached from the battery module, a protruding height of each of the ribs is lower than a protruding height of each of the protrusions.

[4] The battery module according to any one of [1] to [3], wherein the base has a first surface and a second surface facing each other in the first direction, the ribs include a first rib formed on the first surface and a second rib formed on the second surface, the first rib and the second rib are formed at positions different from each other in the second direction or the third direction.

[5] The battery module according to any one of [1] to [4], wherein the insulating member includes a material selected from a group consisting of an ethylene propylene rubber, a urethane rubber, a silicone rubber, and a fluororubber.

[6] The battery module according to any one of [1] to [5], wherein in the state in which the insulating member is detached from the battery module, height and width of each of the ribs are substantially unchanged between the first protrusion and the second protrusion or between the first protrusion and the third protrusion and the height of the rib is twice or more as large as the width of the rib.

[7] The battery module according to any one of [1] to [5], wherein in the state in which the insulating member is detached from the battery module, a width of each of the ribs becomes larger in a tapered shape from a tip of the rib toward the base between the first protrusion and the second protrusion or between the first protrusion and the third protrusion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a battery module.

FIG. 2 is a perspective view showing a battery cell.

FIG. 3 is a plan view of an insulating member.

FIG. 4 is a cross sectional view along A1-A1 in FIG. 3.

FIG. 5 is a cross sectional view along A2-A2 in FIG. 3.

FIG. 6 is a cross sectional view along A3-A3 in FIG. 3.

FIG. 7 is a cross sectional view of an insulating member according to a first modification along A1-A1 in FIG. 3.

FIG. 8 is a cross sectional view of an insulating member according to a second modification along A1-A1 in FIG. 3.

FIG. 9 is a cross sectional view of the insulating member according to the second modification along A2-A2 in FIG. 3.

FIG. 10 is a cross sectional view of the insulating member according to the second modification along A3-A3 in FIG. 3.

FIG. 11 is a plan view of an insulating member according to a third modification.

FIG. 12 is a plan view of an insulating member according to a fourth modification.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include other batteries such as a nickel-metal hydride battery and a sodium ion battery.

In the present specification, the term “battery cell” is not necessarily limited to a prismatic battery cell and may include a cell having another shape, such as a cylindrical battery cell, a pouch battery cell, or a blade battery cell. The “battery cell” can be mounted on vehicles such as a hybrid electric vehicle (HEV), a plug-in hybrid electric vehicle (PHEV), and a battery electric vehicle (BEV). It should be noted that the use of the “battery cell” is not limited to the use in a vehicle.

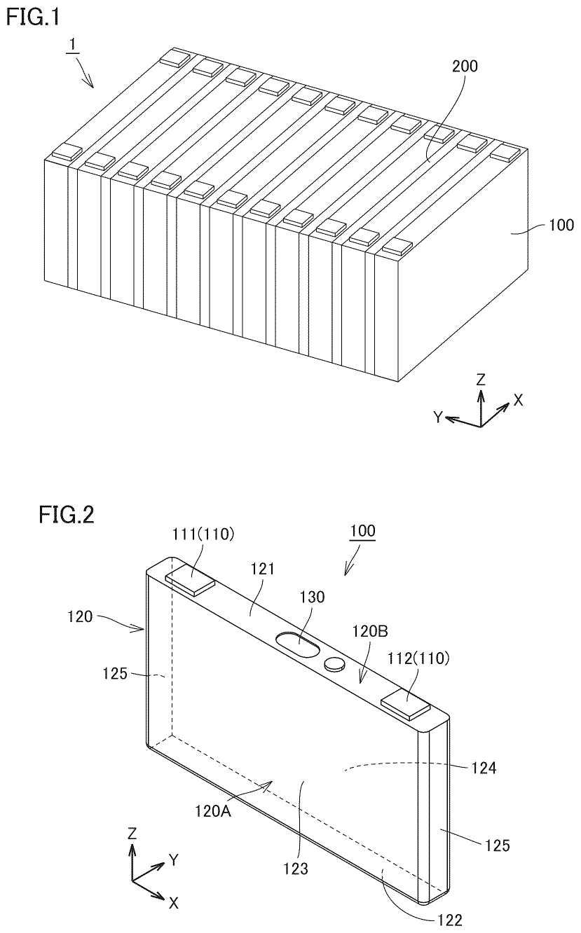

FIG. 1 is a perspective view of a battery module according to the present embodiment. As shown in FIG. 1, a battery module 1 includes battery cells 100 and insulating members 200 (inter-cell separator). Battery cells 100 and insulating members 200 are arranged alternately along a Y axis direction (first direction).

The plurality of battery cells 100 are battery cells each having a prismatic shape, and are provided along the Y axis direction. The plurality of battery cells 100 are electrically connected together by a bus bar (not shown).

Insulating members 200 are provided between the plurality of battery cells 100. Each of insulating members 200 prevents unintended electrical conduction between adjacent battery cells 100. Insulating member 200 secures an electrical insulation property between adjacent battery cells 100.

FIG. 2 is a perspective view showing each battery cell 100. As shown in FIG. 2, battery cell 100 has a prismatic shape. Battery cell 100 has electrode terminals 110, a housing 120, and a gas-discharge valve 130.

Electrode terminals 110 are formed on housing 120. Electrode terminals 110 have a positive electrode terminal 111 and a negative electrode terminal 112 arranged side by side along an X axis direction (second direction) orthogonal to the Y axis direction (first direction). Positive electrode terminal 111 and negative electrode terminal 112 are provided to be separated from each other in the X axis direction.

Housing 120 has a rectangular parallelepiped shape and forms an external appearance of battery cell 100. Housing 120 includes: a case body 120A that accommodates an electrode assembly (not shown) and an electrolyte solution (not shown); and a sealing plate 120B that seals an opening of case body 120A. Sealing plate 120B is joined to case body 120A by welding.

Housing 120 has an upper surface 121, a lower surface 122, a first side surface 123, a second side surface 124, and two third side surfaces 125.

Upper surface 121 is a flat surface orthogonal to a Z axis direction (third direction) orthogonal to the Y axis direction and the X axis direction. Electrode terminals 110 are disposed on upper surface 121. Lower surface 122 faces upper surface 121 along the Z axis direction.

Each of first side surface 123 and second side surface 124 is constituted of a flat surface orthogonal to the Y axis direction. Each of first side surface 123 and second side surface 124 has the largest area among the areas of the plurality of side surfaces of housing 120. Each of first side surface 123 and second side surface 124 has a rectangular shape when viewed in the Y axis direction. Each of first side surface 123 and second side surface 124 has a rectangular shape in which the X axis direction corresponds to the long-side direction and the Z axis direction corresponds to the short-side direction when viewed in the Y axis direction.

The plurality of battery cells 100 are stacked such that first side surfaces 123 of battery cells 100, 100 adjacent to each other in the Y direction face each other and second side surfaces 124 of battery cells 100, 100 adjacent to each other in the Y axis direction face each other. Thus, positive electrode terminals 111 and negative electrode terminals 112 are alternately arranged in the Y axis direction in which the plurality of battery cells 100 are stacked.

Gas-discharge valve 130 is provided in upper surface 121. When the temperature of battery cell 100 is increased (thermal runaway) and internal pressure of housing 120 becomes more than or equal to a predetermined value due to gas generated inside housing 120, gas-discharge valve 130 discharges the gas to outside of housing 120.

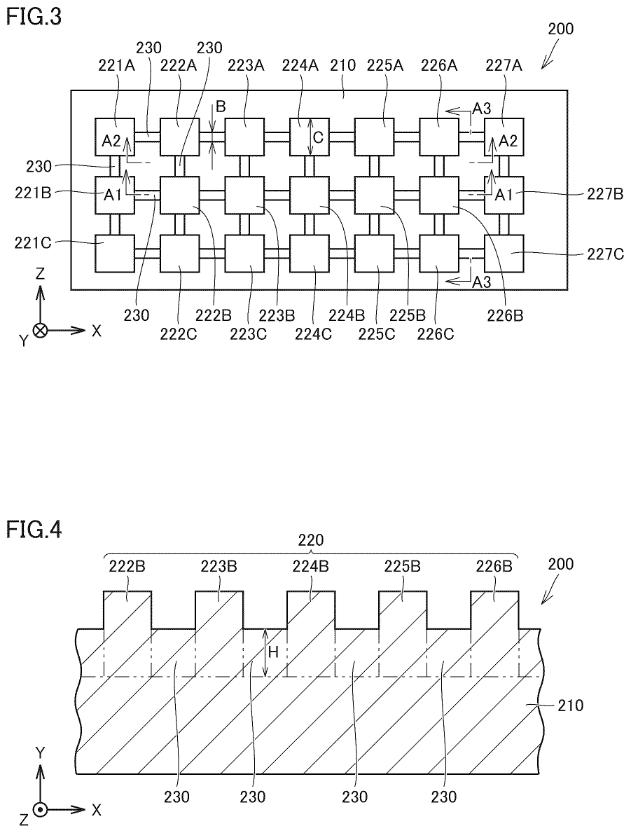

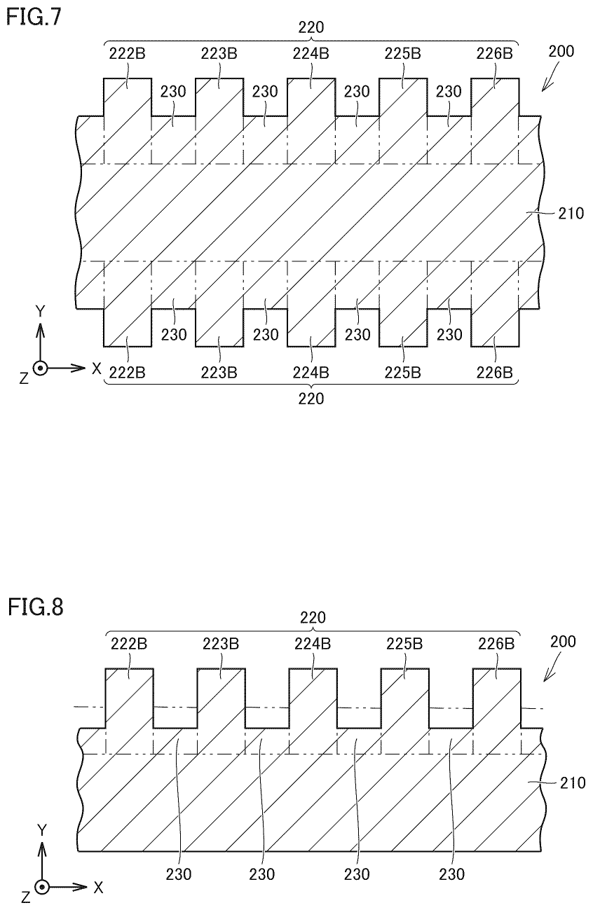

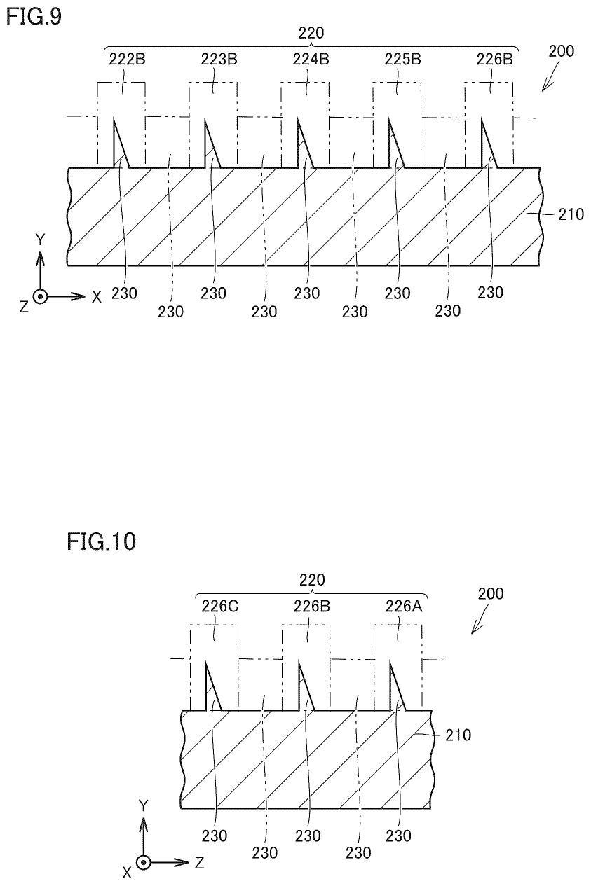

FIG. 3 is a plan view of insulating member 200, and FIGS. 4 to 6 are cross sectional views along A1-A1, A2-A2, and A3-A3 in FIG. 3, respectively. It should be noted that each of FIGS. 3 to 6 as well as FIGS. 7 to 12 described later shows a state in which insulating member 200 is detached from battery module 1.

As shown in FIGS. 3 to 6, insulating member 200 includes: a base 210; a plurality of protrusions 220 each protruding from base 210 in the Y axis direction; and ribs 230 protruding from base 210 in the Y axis direction so as to connect between the plurality of protrusions 220. Insulating member 200 including base 210, protrusions 220, and ribs 230 can be formed by integral molding.

Insulating member 200 may be composed of a material having an electrical insulation property and elasticity, such as an ethylene propylene rubber (EPDM), a urethane rubber (U), a silicone rubber (Si), or a fluororubber, for example.

In the example shown in FIG. 3, protrusions 220 are arranged in the form of a matrix such that seven protrusions (221A to 227A, 221B to 227B and 221C to 227C) are arranged evenly in the X axis direction and three protrusions (221A to 221C, 222A to 222C, 223A to 223C, 224A to 224C, 225A to 225C, 226A to 226C and 227A to 227C) are arranged evenly in the Z axis direction.

It should be noted that the number, shape (quadrangular shape, other polygonal shape, circular shape, or the like), protruding height, arrangement (arrangement direction or interval), and size of the plurality of protrusions 220 can be changed appropriately. Parts of the plurality of protrusions 220 may be made different from each other in terms of shape, protruding height, arrangement, and size.

Each of ribs 230 is provided between the plurality of protrusions 220. In the example of FIG. 3, ribs 230 are formed to connect the plurality of protrusions 220 together. For example, a rib 230 extending in the X axis direction is formed to connect protrusion 221A (first protrusion) and protrusion 222A (second protrusion) arranged side by side in the X axis direction, and a rib 230 extending in the Z axis direction is formed to connect protrusion 221A (first protrusion) and protrusion 221B (third protrusion) arranged side by side in the Z axis direction. A rib 230 extending in the X axis direction or the Z axis direction is also provided between the other protrusions 220 in the same manner as described above.

As shown in FIG. 3, in the state in which insulating member 200 is detached from battery module 1, the width (B) of each of ribs 230 is smaller than the width (C) of each of protrusions 220.

As shown in FIGS. 4 to 6, in the state in which insulating member 200 is detached from battery module 1, the protruding height (H) of each of ribs 230 is lower than the protruding height of each of protrusions 220.

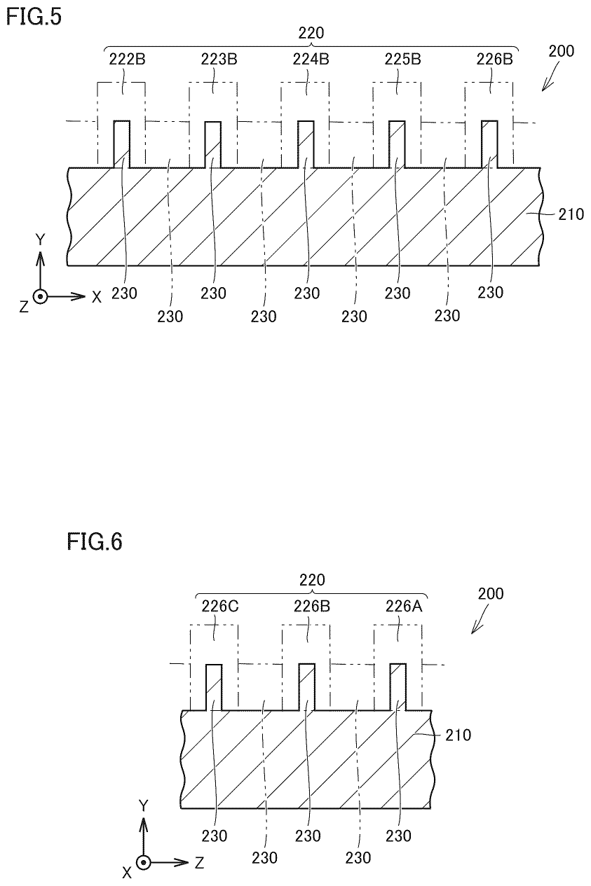

As shown in FIGS. 5 and 6, rib 230 has a quadrangular cross sectional shape when viewed in each of the extending directions (the X axis direction and the Z axis direction). Further, the height and width of rib 230 are unchanged between the plurality of protrusions 220. On this occasion, the height (H) of rib 230 is preferably about twice or more as large as the width (B) thereof (H/B≥2).

From the viewpoint of reducing the size of battery module 1, the thickness of insulating member 200 is desirably thin. However, if base 210 is too thin, handleability of insulating member 200 may be deteriorated when assembling insulating member 200 between the plurality of battery cells 100.

To address this, in battery module 1 according to the present embodiment, ribs 230 extend in the two directions, i.e., the X axis direction and the Z axis direction to connect the plurality of protrusions 220 on base 210, thereby improving rigidity of base 210. As a result, the handleability of insulating member 200 when assembling it to battery module 1 can be improved. Further, since base 210 can be made thin (to, for example, a thickness of about 0.5 mm or less) while securing predetermined rigidity, the protruding height of protrusion 220 can be set to be high without excessively increasing the thickness of insulating member 200, with the result that a size absorption property (error absorption property or deformation absorption property) by elastic deformation of protrusion 220 can be increased.

Further, since the protruding height (H) of rib 230 is lower than the protruding height of protrusion 220, a space surrounded by protrusion 220 and rib 230 is not closed. Therefore, the elasticity of protrusion 220 can be suppressed from being varied due to air pressure in the closed space, thereby stabilizing an elastic constant of protrusion 220.

FIG. 7 is a cross sectional view of an insulating member according to a first modification along A1-A1 in FIG. 3. In the example of FIG. 7, protrusions 220 are formed on both surfaces of insulating member 200. That is, ribs 230 include: ribs 231 (first rib) each formed on a front surface (first surface) of base 210; and ribs 232 (second rib) each formed on a rear surface (second surface) of base 210.

As in the example of FIG. 7, since protrusions 220 are formed on the both surfaces of insulating member 200, the size absorption property of insulating member 200 by the elastic deformation of the protrusions can be increased.

FIGS. 8 to 10 are cross sectional views of an insulating member 200 according to a second modification along A1-A1, A2-A2, and A3-A3 in FIG. 3, respectively. In the example of FIGS. 8 to 10, in the state in which insulating member 200 is detached from battery module 1, the width of each of ribs 230 becomes larger in a tapered shape from the vertex (tip) of rib 230 toward base 210. In the examples of FIGS. 8 to 10, cross sections with the tapered shapes are formed to be bilaterally asymmetrical (asymmetrical with respect to the Y axis direction) when viewed in each of the extending directions (the X axis direction and the Z axis direction) of ribs 230.

As in the examples of FIGS. 8 to 10, since the cross section of each of ribs 230 is formed to have a triangular shape increased in width in the tapered shape, a top portion of rib 230 can be formed to be thin. Further, since the cross sectional shapes of ribs 230 are bilaterally asymmetrical (asymmetrical with respect to the Y axis direction) when viewed in each of the extending directions (the X axis direction and the Z axis direction) of ribs 230, it is possible to control a deformation direction of each rib 230 that is deformed in response to deformation of protrusion 220. Specifically, rib 230 can be facilitated to be collapsed. As a result, an influence of the presence of rib 230 over the elastic property of protrusion 220 can be made small, thereby suppressing the elastic property of protrusion 220 from being varied.

The cross sectional shape of rib 230 is not limited to the above-described quadrangular shape or triangular shape, and may be, for example, a cross sectional shape including a curve in part of its contour. Further, rib 230 may have a shape that does not have a vertex at its tip (for example, the upper end thereof is formed in the form of a surface).

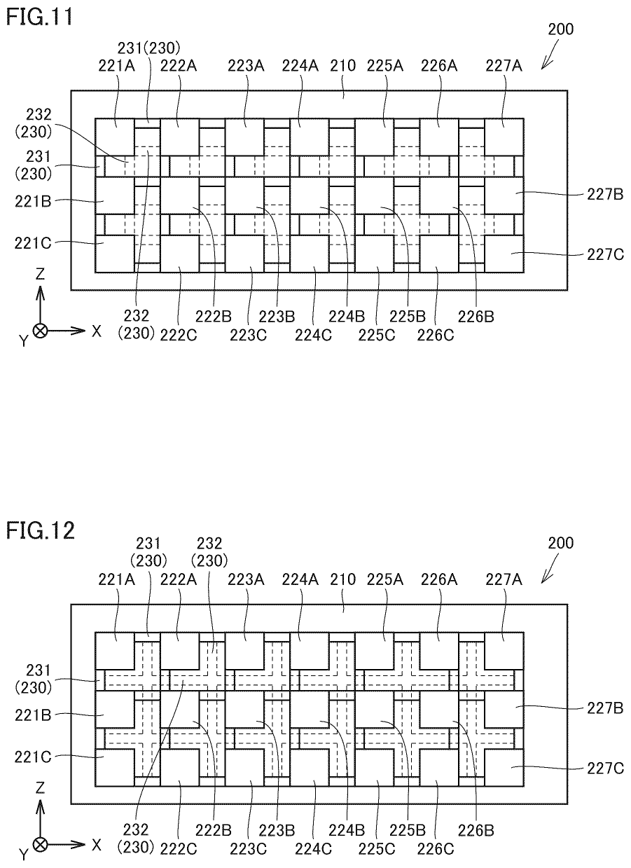

Next, insulating members 200 according to third and fourth modifications will be described with reference to FIGS. 11 and 12. Specifically, further modifications of the arrangement of ribs 230 in insulating member 200 will be described.

In the examples of FIGS. 11 and 12, ribs 230 are formed such that a rib 231 on the front surface of base 210 and a rib 232 on the rear surface of base 210 are formed at positions different from each other in the X axis direction or the Z axis direction. As in the examples of FIGS. 11 and 12, the arrangement of ribs 230 can be appropriately changed.

It should be noted that when sufficient handleability of insulating member 200 is attained by forming protrusions 220 having different heights on the respective surfaces of insulating member 200 and providing ribs 230 on only one of the surfaces of insulating member 200, ribs 230 can be formed on the surface on which higher protrusions 220 are formed.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A battery module comprising:
a plurality of battery cells arranged in a first direction; and
an insulating member provided between the plurality of battery cells, wherein
the insulating member includes a base and a plurality of protrusions each protruding from the base in the first direction, the plurality of protrusions being in abutment with at least one of the plurality of battery cells,
the protrusions include a first protrusion, a second protrusion arranged beside the first protrusion along a second direction orthogonal to the first direction, and a third protrusion arranged beside the first protrusion along a third direction that is orthogonal to the first direction and that intersects the second direction,
ribs each protruding from the base in the first direction are provided between the first protrusion and the second protrusion and between the first protrusion and the third protrusion, and
in a state in which the insulating member is detached from the battery module, a width of each of the ribs is smaller than a width of each of the protrusions.

2. The battery module according to claim 1, wherein the ribs are formed to connect the first protrusion and the second protrusion to each other and connect the first protrusion and the third protrusion to each other.

3. The battery module according to claim 1, wherein in the state in which the insulating member is detached from the battery module, a protruding height of each of the ribs is lower than a protruding height of each of the protrusions.

4. The battery module according to claim 1, wherein
the ribs are formed to connect the first protrusion and the second protrusion to each other and connect the first protrusion and the third protrusion to each other, and
in the state in which the insulating member is detached from the battery module, a protruding height of each of the ribs is lower than a protruding height of each of the protrusions.

5. The battery module according to claim 1, wherein
the base has a first surface and a second surface facing each other in the first direction,
the ribs include a first rib formed on the first surface and a second rib formed on the second surface, and
the first rib and the second rib are formed at positions different from each other in the second direction or the third direction.

6. The battery module according to claim 1, wherein
the ribs are formed to connect the first protrusion and the second protrusion to each other and connect the first protrusion and the third protrusion to each other,
the base has a first surface and a second surface facing each other in the first direction,
the ribs include a first rib formed on the first surface and a second rib formed on the second surface, and
the first rib and the second rib are formed at positions different from each other in the second direction or the third direction.

7. The battery module according to claim 1, wherein
in the state in which the insulating member is detached from the battery module, a protruding height of each of the ribs is lower than a protruding height of each of the protrusions,
the base has a first surface and a second surface facing each other in the first direction,
the ribs include a first rib formed on the first surface and a second rib formed on the second surface, and
the first rib and the second rib are formed at positions different from each other in the second direction or the third direction.

8. The battery module according to claim 1, wherein
the ribs are formed to connect the first protrusion and the second protrusion to each other and connect the first protrusion and the third protrusion to each other,
in the state in which the insulating member is detached from the battery module, a protruding height of each of the ribs is lower than a protruding height of each of the protrusions,
the base has a first surface and a second surface facing each other in the first direction,
the ribs include a first rib formed on the first surface and a second rib formed on the second surface, and
the first rib and the second rib are formed at positions different from each other in the second direction or the third direction.

9. The battery module according to claim 1, wherein the insulating member includes a material selected from a group consisting of an ethylene propylene rubber, a urethane rubber, a silicone rubber, and a fluororubber.

10. The battery module according to claim 1, wherein
the ribs are formed to connect the first protrusion and the second protrusion to each other and connect the first protrusion and the third protrusion to each other,
in the state in which the insulating member is detached from the battery module, a protruding height of each of the ribs is lower than a protruding height of each of the protrusions,
the base has a first surface and a second surface facing each other in the first direction,
the ribs include a first rib formed on the first surface and a second rib formed on the second surface,
the first rib and the second rib are formed at positions different from each other in the second direction or the third direction, and
the insulating member includes a material selected from a group consisting of an ethylene propylene rubber, a urethane rubber, a silicone rubber, and a fluororubber.

11. The battery module according to claim 1, wherein in the state in which the insulating member is detached from the battery module, height and width of each of the ribs are substantially unchanged between the first protrusion and the second protrusion or between the first protrusion and the third protrusion and the height of the rib is twice or more as large as the width of the rib.

12. The battery module according to claim 1, wherein
the ribs are formed to connect the first protrusion and the second protrusion to each other and connect the first protrusion and the third protrusion to each other,
in the state in which the insulating member is detached from the battery module, a protruding height of each of the ribs is lower than a protruding height of each of the protrusions,
the base has a first surface and a second surface facing each other in the first direction,
the ribs include a first rib formed on the first surface and a second rib formed on the second surface,
the first rib and the second rib are formed at positions different from each other in the second direction or the third direction,
the insulating member includes a material selected from a group consisting of an ethylene propylene rubber, a urethane rubber, a silicone rubber, and a fluororubber, and
in the state in which the insulating member is detached from the battery module, height and width of each of the ribs are substantially unchanged between the first protrusion and the second protrusion or between the first protrusion and the third protrusion and the height of the rib is twice or more as large as the width of the rib.

13. The battery module according to claim 1, wherein in the state in which the insulating member is detached from the battery module, a width of each of the ribs becomes larger in a tapered shape from a tip of the rib toward the base between the first protrusion and the second protrusion or between the first protrusion and the third protrusion.

14. The battery module according to claim 1, wherein
the ribs are formed to connect the first protrusion and the second protrusion to each other and connect the first protrusion and the third protrusion to each other,
in the state in which the insulating member is detached from the battery module, a protruding height of each of the ribs is lower than a protruding height of each of the protrusions,
the base has a first surface and a second surface facing each other in the first direction,
the ribs include a first rib formed on the first surface and a second rib formed on the second surface,
the first rib and the second rib are formed at positions different from each other in the second direction or the third direction,
the insulating member includes a material selected from a group consisting of an ethylene propylene rubber, a urethane rubber, a silicone rubber, and a fluororubber, and
in the state in which the insulating member is detached from the battery module, a width of each of the ribs becomes larger in a tapered shape from a tip of the rib toward the base between the first protrusion and the second protrusion or between the first protrusion and the third protrusion.
